(19) United States
(12) Patent Application Publication
(10) Pub. No.: US 2024/0132802 A1
(43) Pub. Date: Apr. 25, 2024

(54) Candle Creating Kit

(71) Applicant: Marry Laneece Campbell, Indianapolis, IN (US)

(72) Inventor: Marry Laneece Campbell, Indianapolis, IN (US)

(21) Appl. No.: 17/973,479

(22) Filed: Oct. 24, 2022

(51) Int. Cl. C11C 5/02; C11C 5/00

(52) U.S. Cl. CPC C11C 5/02; C11C 5/006; C11C 5/008

(57) ABSTRACT

A candle creating kit includes a vase, a first container containing a liquid resin, a second container containing a gel wax, a third container containing a powder is comprised of a light reflecting material and a fourth container containing a liquid pigment. The liquid resin and the gel wax are poured into the vase in alternating layers and a desired amount of the power and pigment are mixable into the resin. A block of candle wax is heatable into a fluid wax which can be poured into the vase. A wick is insertable into the fluid wax before the fluid wax hardens thereby facilitating the fluid wax to be burned in the wick when the wick is ignited to illuminate the immediate area around the vase.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to candle devices and more particularly pertains to a new candle kit for creating a customized candle. The device includes a vase, a first container containing a liquid resin, a second container containing a gel wax, a third container containing a powder is comprised of a light reflecting material and a fourth container containing a liquid pigment. The kit includes a block of candle wax that is heatable into a fluid wax and a wick that is insertable into the fluid wax. The device includes an ornament that can be positioned in the liquid resin such that the ornament is embedded in the liquid resin.

### (2) Description of Related Art Including Information Disclosed Under 37 CFR 1.97 and 1.98

The prior art relates to candle devices including a candle that includes an inflammable body positioned between a combustible oil and a bottom of a container. The prior art discloses an ornamental device that includes a decorative gel containing crystals that form in situ in the gel from an additive. The prior art discloses a scented candle that has at least two different wax materials which each has different melting points. The prior art discloses a method of forming a candle which has a luminescent layer. The prior art discloses a candle device that has infused scents for aromatherapy. The prior art discloses a candle kit that includes a decorative wrapper that is positionable around a candle. The prior art discloses a scented candle device that includes a container and a scented gel that is pourable into the container.

### BRIEF SUMMARY OF THE INVENTION

An embodiment of the disclosure meets the needs presented above by generally comprising a vase, a first container containing a liquid resin, a second container containing a gel wax, a third container containing a powder is comprised of a light reflecting material and a fourth container containing a liquid pigment. The liquid resin and the gel wax are poured into the vase in alternating layers and a desired amount of the power and pigment are mixable into the resin. A block of candle wax is heatable into a fluid wax which can be poured into the vase. A wick is insertable into the fluid wax before the fluid wax hardens thereby facilitating the fluid wax to be burned in the wick when the wick is ignited to illuminate the immediate area around the vase.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an embodiment of the disclosure.

FIG. 2 is a bottom perspective view of an embodiment of the disclosure.

FIG. 3 is a front view of an embodiment of the disclosure.

FIG. 4 is a perspective view of a candle creating kit according to an embodiment of the disclosure.

FIG. 5 is a perspective in-use view of an embodiment of the disclosure.

### DETAILED DESCRIPTION OF THE INVENTION

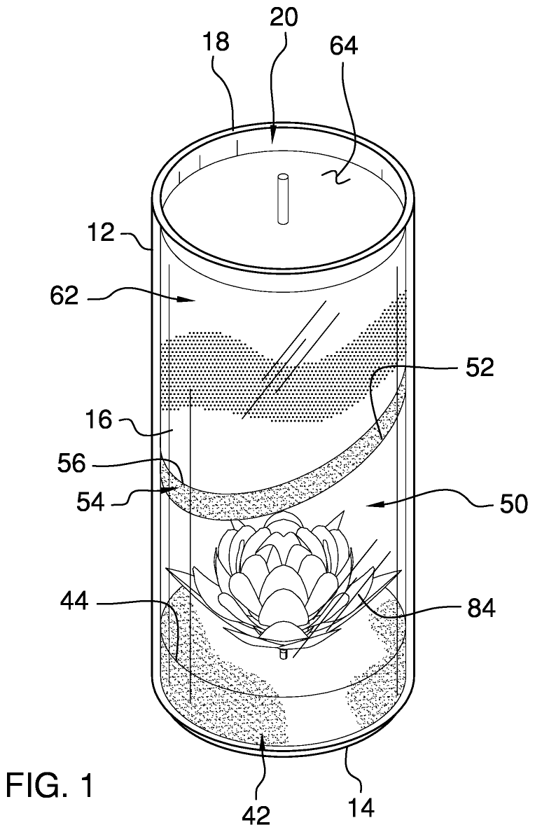

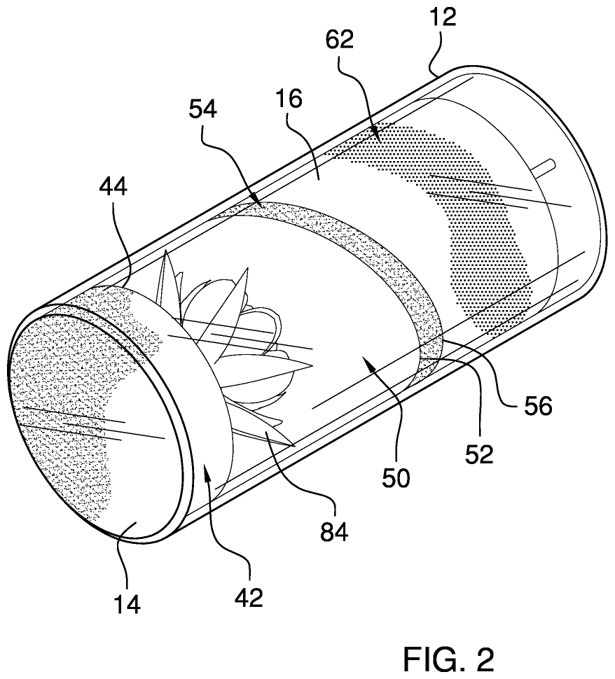

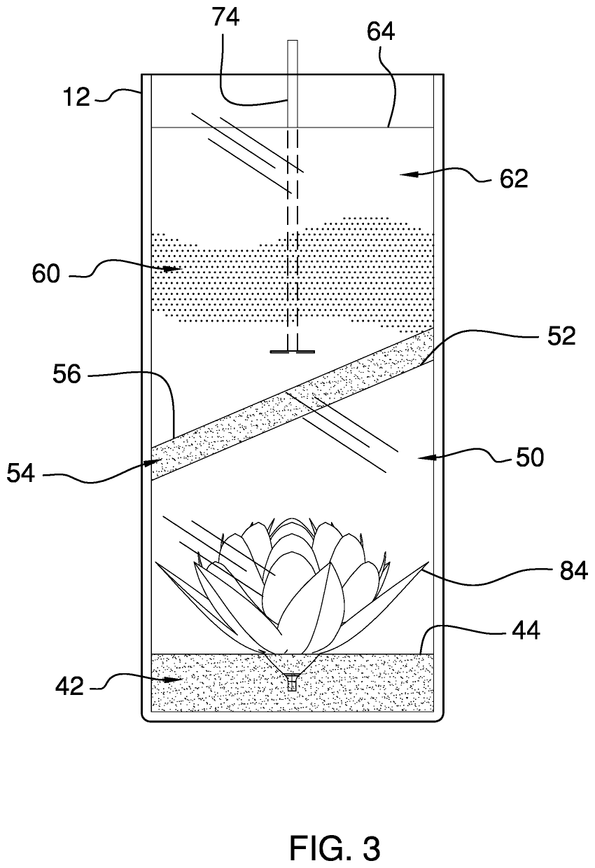

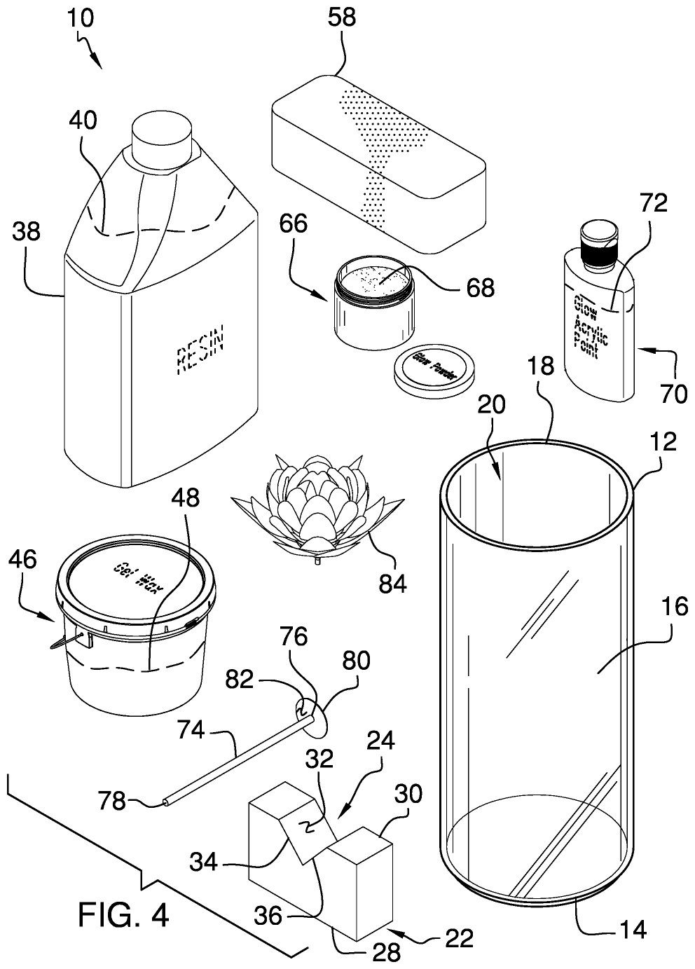

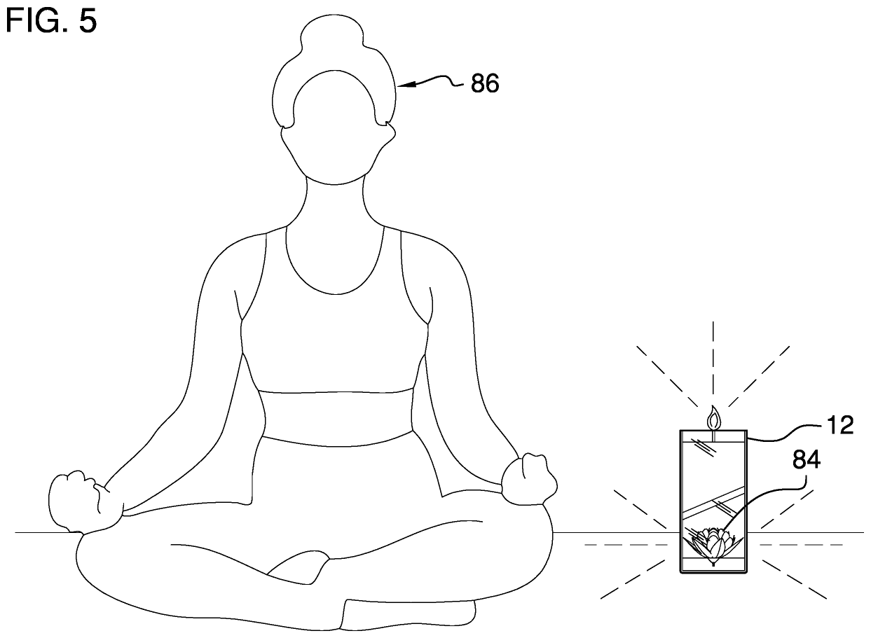

With reference now to the drawings, and in particular to FIGS. 1 through 5 thereof, a new candle kit embodying the principles and concepts of an embodiment of the disclosure and generally designated by the reference numeral 10 will be described.

As best illustrated in FIGS. 1 through 5, the candle creating kit 10 generally comprises a vase 12 that is comprised of a translucent material such that the vase 12 can pass light through the vase 12. The vase 12 may be comprised of glass, plastic or other similarly rigid material that is also translucent. Furthermore, the vase 12 may have a height ranging between approximately 12.0 cm and 25 cm and a diameter ranging between approximately 7.0 cm and 12.0 cm such that the vase 12 has dimensions similar to that commonly associated with a candle. The vase 12 has a bottom wall 14 and an outer wall 16 extending upwardly from the bottom wall 14 and the outer wall 16 is continuously arcuate about a center point of the bottom wall 14 such that the vase 12 has a cylindrical shape. Additionally, the outer wall 16 has a distal edge 18 with respect to the bottom wall 14 defining an opening 20 into the vase 12.

A base 22 is provided which has a notch 24 integrated into the base 22 and the base 22 is positionable on a horizontal support surface 26 such that the notch 24 is exposed. The vase 12 is positionable in the notch 24 thereby facilitating the vase 12 to be oriented at an angle with respect to the horizontal support surface 26. The base 22 has a lower side 28 and a top side 30 and the notch 24 extends downwardly in the top side 30 toward the lower side 28. Furthermore, the notch 24 has a bounding surface 32 and the bounding surface 32 has a first side 34 intersecting a second side 36 at an angle such that the notch 24 has a triangular shape. The bottom wall 14 of the vase 12 rests against the first side 34 and the outer wall 16 of the vase 12 rests against the second side 36 when the vase 12 is positioned in the notch 24. The horizontal support surface 26 may be a table top or other similar type of horizontal support surface that is commonly employed as a work surface.

A first container 38 is provided which contains a liquid resin 40 and a predetermined amount of the liquid resin 40 is pourable from the first container 38 into the vase 12 such that the liquid resin 40 hardens into a first layer 42 in the vase 12. Additionally, the first layer 42 rests on the bottom wall 14 and the first layer 42 has an upper surface 44. The first container 38 may comprise a bottle with a fluid volume of at least 2.0 liters. A second container 46 is provided which contains a gel wax 48 and a predetermined amount of the gel wax 48 is pourable from the second container 46 onto the first layer 42 formed by the liquid resin 40 such that the gel wax 48 hardens into a second layer 50 in the vase 12. The second container 46 may comprise a bucket with a lid and the bucket may have a volume of at least 2.0 liters.

The vase 12 is positioned in the notch 24 in the base 22 thereby orienting the vase 12 at an angle when the gel wax 48 is poured into the vase 12 such that the second layer 50 has a diagonal orientation. Furthermore, the second layer 50 rests upon the upper surface 44 of the first layer 42. The second layer 50 has an upper surface 52 that is oriented at an upward angle with respect to the bottom wall 14. Additionally, a predetermined amount of the liquid resin 40 is pourable from the first container 38 onto the second layer 50 formed by the gel wax 48 such that the liquid resin 40 hardens into a third layer 54 in the vase 12. The vase 12 remains in the notch 24 in the base 22 thereby orienting the vase 12 at the angle when the liquid resin 40 is poured into the vase 12 such that the third layer 54 has a diagonal orientation. The third layer 54 rests upon the upper surface 52 of the second layer 50 and the third layer 54 has an upper surface 56 that is oriented at an upward angle lying on a plane that is oriented coplanar with the upper surface 52 of the second layer 50.

A block of candle wax 58 is provided and the block of candle wax 58 is heatable into a fluid wax 60. A predetermined amount of the fluid wax 60 is pourable onto the third layer 54 formed by the liquid resin 40 such that the fluid wax 60 hardens into a fourth layer 62 in the vase 12. Additionally, the vase 12 is removed from the notch 24 in the base 22 prior to pouring the fluid wax 60 into the vase 12 thereby facilitating the vase 12 to be positioned on the horizontal support surface 26. In this way the vase 12 is oriented in a vertical orientation when the fluid wax 60 is poured into the vase 12 such that the fluid wax 60 has a horizontal orientation. The fourth layer 62 rests upon the upper surface 56 of the third layer 54 and the fourth layer 62 has an upper surface 64 lies on a plane that is oriented parallel with the bottom wall 14 of the vase 12.

A third container 66 is provided which containing a powder 68 that is comprised of a light reflecting material. A predetermined amount of the powder 68 is mixed with the predetermined amount of the liquid resin 40 which forms the first layer 42 thereby facilitating the first layer 42 to sparkle. In this way the powder 68 enhances the ornamental appearance of the first layer 42. Furthermore, a predetermined amount of the powder 68 is mixed with the predetermined amount of the liquid resin 40 which forms the third layer 54 thereby facilitating the third layer 54 to sparkle. In this way the powder 68 enhances the ornamental appearance of the third layer 54. The powder 68 may be comprised of metallic particles or other type of similarly heat resistant material that is additionally capable of reflecting light.

A fourth container 70 is provided which contains a liquid pigment 72. A predetermined amount of the liquid pigment 72 is mixed with the predetermined amount of the liquid resin 40 which forms the first layer 42 thereby facilitating the liquid pigment 72 to alter the color of the first layer 42. In this way the liquid pigment 72 enhances the ornamental appearance of the first layer 42. The liquid pigment 72 may comprise an acrylic pigment or other similar type of pigment and the liquid pigment 72 may be provided in a variety of bright colors such that the liquid pigment 72 facilitates the first layer 42 to be highly visible through the vase 12.

A wick 74 is insertable into the fourth layer 62 defined by the fluid wax 60 before the fluid wax 60 hardens thereby facilitating the wick 74 to be embedded into the fourth layer 62 when the fourth layer 62 hardens. The block of candle wax 58 is comprised of a combustible material thereby facilitating the fluid wax 60 to be burned in the wick 74 when the wick 74 is ignited to emit light for illuminating the immediate area around the vase 12. The wick 74 has a lower end 76 and an upper end 78 and the wick 74 includes a disk 80 which has a top surface 82. The lower end 76 of the wick 74 is attached to the top surface 82 of the disk 80 such that the disk 80 is embedded in the fourth layer 62 when the fourth layer 62 hardens. In this way the disk 80 inhibits the wick 74 from being removable from the fourth layer 62. Additionally, the wick 74 extends upwardly through the upper surface 64 of the fourth layer 62 such that the upper end 78 of the wick 74 is exposed.

An ornament 84 is provided and the ornament 84 is positionable within the vase 12 when the gel wax 48 is poured into the vase 12. In this way the ornament 84 is embedded in the gel wax 48 when the gel wax 78 hardens in the vase 12. The gel wax 48 is comprised of a translucent material thereby facilitating the ornament 84 to be visible in the gel wax 48. In this way the ornament 84 can enhance the ornamental appearance of the vase 12. The ornament 84 may comprise an artificial flower, a religious symbol, a spiritual symbol or any other type of ornament 84 that might have significance for a user 86 such that the user 86 is inspired by the sight of the ornament 84.

In use, the vase 12 is positioned on the horizontal support surface 26 and a predetermined amount of the liquid pigment 72 and a predetermined amount of the powder 68 are mixed into the predetermined amount of the liquid resin 40 which is poured into the vase 12 to define the first layer 42. Additionally, the ornament 84 is positioned in the vase 12 such that the ornament 84 is partially submerged in the mixture of liquid pigment 72, powder 68 and liquid resin 40. The mixture of liquid pigment 72, powder 68 and liquid resin 40 are given sufficient time to harden such that the mixture of pigment, powder 68 and liquid resin 40 define the first layer 42 in the vase 12. The first layer 42 comprises approximately 2.0 ounces of the mixture of liquid pigment 72, powder 68 and liquid resin 40.

The vase 12 is subsequently positioned in the notch 24 in the base 22 to orient the vase 12 an angle and the predetermined amount of the gel wax 48 is poured into the vase 12. Furthermore, the gel wax 48 is given sufficient time to harden such that the gel wax 48 defines the second layer 50. Additionally, the angle of the vase 12 facilitates the upper surface 52 of the second layer 50 to be oriented at a diagonal angle in the vase 12. The vase 12 is left in the notch 24 in the base 22 while a predetermined amount of the powder 68 is mixed with a predetermined amount of the liquid resin 40. The subsequent mixture of powder 68 and liquid resin 40 is poured into the vase 12 while the vase 12 is positioned at the angle in the notch 24 in the base 22. The mixture of powder 68 and liquid resin 40 is given sufficient time to harden such that the mixture of powder 68 and liquid resin 40 defines the third layer 54. Furthermore, the third layer 54 comprises approximately 1.5 ounces of the mixture of powder 68 and liquid resin 40.

The vase 12 is removed from the base 22 once the third layer 54 has had sufficient time to hard and the predetermined amount of candle wax 58 is melted into the fluid wax 60, by heating the candle wax 58 in a pot on a stove for example. The fluid wax 60 is poured into the vase 12 and the wick 74 is inserted into the fluid wax 60. In this way the wick 74 is embedded in the fluid wax 60 and the fluid wax 60 is given sufficient time to harden into the fourth layer 62. The wick 74 is ignited at any time after the fluid wax 60 has hardened into the fourth layer 62 to burn the fourth layer 62 in the convention of a candle. In this way the user 86 can enjoy the visual appeal of the vase 12, burning wick 74 and the ornament 84 while the user 86 is practicing meditation, for example, or other calming activity. Additionally, the first layer 42 and the third layer 54 become luminescent when an exterior source of light, such as sunlight for example, passes through the vase 12 and the first layer 42 and the third layer 54.

With respect to the above description then, it is to be realized that the optimum dimensional relationships for the parts of an embodiment enabled by the disclosure, to include variations in size, materials, shape, form, function and manner of operation, kit and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A candle creating kit for facilitating a user to produce a customized candle for the purposes of enhancing meditation practice, said kit comprising:
a vase being comprised of a translucent material wherein said vase is configured to pass light through said vase;
a base having a notch being integrated into said base, said base being positionable on a horizontal support surface such that said notch is exposed, said vase being positionable in said notch thereby facilitating said vase to be oriented at an angle with respect to the horizontal support surface;
a first container containing a liquid resin, a predetermined amount of said liquid resin being pourable from said first container into said vase such that said liquid resin hardens into a first layer in said vase;
a second container containing a gel wax, a predetermined amount of said gel wax being pourable from said second container onto said first layer formed by said liquid resin such that said gel wax hardens into a second layer in said vase, said vase being positioned in said notch in said base thereby orienting said vase at an angle when said gel wax is poured into said vase such that said second layer has a diagonal orientation;
wherein a predetermined amount of said liquid resin is pourable from said first container onto said second layer formed by said gel wax such that said liquid resin hardens into a third layer in said vase, said vase being positioned in said notch in said base thereby orienting said vase at said angle when said liquid resin is poured into said vase such that said third layer has a diagonal orientation;
a block of candle wax being heatable into a fluid wax, a predetermined amount of said fluid wax being pourable onto said third layer formed by said liquid resin such that said fluid wax hardens into a fourth layer in said vase, said vase being removed from said notch in said base thereby facilitating said vase to be positioned on the horizontal support surface thereby facilitating said vase to be oriented in a vertical orientation when said fluid wax is poured into said vase such that said fluid wax has a horizontal orientation;
a third container containing a powder being comprised of a light reflecting material, a predetermined amount of said powder being mixed with a respective one of said first layer or said second layer or said third layer or said fourth layer;
a fourth container containing liquid pigment, a predetermined amount of said pigment being mixed with a respective one of said first layer or said second layer or said third layer or said fourth layer; and
a wick being insertable into said fourth layer defined by said fluid wax before said fluid wax hardens thereby facilitating said wick to be embedded into said fourth layer when said fourth layer hardens, said block of candle wax being comprised of a combustible material thereby facilitating said fluid wax to be burned in said wick when said wick is ignited wherein said wick is configured to emit light for illuminating the immediate area around said vase.

2. The kit according to claim 1, wherein:
said vase has a bottom wall and an outer wall extending upwardly from said bottom wall, said outer wall being continuously arcuate about a center point of said bottom wall such that said vase has a cylindrical shape, said outer wall having a distal edge with respect to said bottom wall defining an opening into said vase; and
said base has a lower side and a top side, said notch extending downwardly in said top side toward said lower side, said notch having a bounding surface, said bounding surface having a first side intersecting a second side at an angle such that said notch has a triangular shape, said bottom wall of said vase resting against said first side having said outer wall of said vase resting against said second side when said vase is positioned in said notch.

3. The kit according to claim 2, wherein said first layer rests on said bottom wall of said vase, said first layer having an upper surface.

4. The kit according to claim 4, wherein said second layer rests upon said upper surface of said first layer, said second layer having an upper surface being oriented at an upward angle with respect to said bottom wall of said vase.

5. The kit according to claim 4, wherein said third layer rests upon said upper surface of said second layer, said third layer having an upper surface being oriented at an upward angle lying on a plane being oriented coplanar with said upper surface of said second layer.

6. The kit according to claim 5, wherein said fourth layer rests upon said upper surface of said third layer, said fourth layer having an upper surface lying on a plane being oriented parallel with said bottom wall of said vase.

7. The kit according to claim 1, wherein a predetermined amount of said powder is mixed with said predetermined amount of said liquid resin which forms said third layer thereby facilitating said third layer to sparkle wherein said powder is configured to enhance the ornamental appearance of said third layer.

8. The kit according to claim 1, wherein a predetermined amount of said powder is mixed with said predetermined amount of said liquid resin which forms said first layer thereby facilitating said first layer to sparkle wherein said powder is configured to enhance the ornamental appearance of said first layer.

9. The kit according to claim 1, wherein a predetermined amount of said liquid pigment is mixed with said predetermined amount of said liquid resin which forms said first layer thereby facilitating said liquid pigment to alter the color of said first layer wherein said liquid pigment is configured to enhance the ornamental appearance of said first layer.

10. The kit according to claim 6, wherein said wick has a lower end and an upper end, said wick including a disk having a top surface, said lower end of said wick being attached to said top surface of said disk such that said disk is embedded in said fourth layer when said fourth layer hardens thereby inhibiting said wick from being removable from said fourth layer, said wick extending upwardly through said upper surface of said fourth layer such that said upper end of said wick is exposed.

11. The kit according to claim 1, further comprising an ornament being positionable within said vase when said gel wax is poured into said vase, said ornament being embedded in said gel wax when said gel was hardens in said vase, said gel wax being comprised of a translucent material thereby facilitating said ornament to be visible in said gel wax wherein said ornament is configured to enhance the ornamental appearance of said vase.

12. A candle creating kit for facilitating a user to produce a customized candle for the purposes of enhancing meditation practice, said kit comprising:
a vase being comprised of a translucent material wherein said vase is configured to pass light through said vase, said vase having a bottom wall and an outer wall extending upwardly from said bottom wall, said outer wall being continuously arcuate about a center point of said bottom wall such that said vase has a cylindrical shape, said outer wall having a distal edge with respect to said bottom wall defining an opening into said vase;
a base having a notch being integrated into said base, said base being positionable on a horizontal support surface such that said notch is exposed, said vase being positionable in said notch thereby facilitating said vase to be oriented at an angle with respect to the horizontal support surface, said base having a lower side and a top side, said notch extending downwardly in said top side toward said lower side, said notch having a bounding surface, said bounding surface having a first side intersecting a second side at an angle such that said notch has a triangular shape, said bottom wall of said vase resting against said first side having said outer wall of said vase resting against said second side when said vase is positioned in said notch;
a first container containing a liquid resin, a predetermined amount of said liquid resin being pourable from said first container into said vase such that said liquid resin hardens into a first layer in said vase, said first layer resting on said bottom wall, said first layer having an upper surface;
a second container containing a gel wax, a predetermined amount of said gel wax being pourable from said second container onto said first layer formed by said liquid resin such that said gel wax hardens into a second layer in said vase, said vase being positioned in said notch in said base thereby orienting said vase at an angle when said gel wax is poured into said vase such that said second layer has a diagonal orientation, said second layer resting upon said upper surface of said first layer, said second layer having an upper surface being oriented at an upward angle with respect to said bottom wall;
wherein a predetermined amount of said liquid resin is pourable from said first container onto said second layer formed by said gel wax such that said liquid resin hardens into a third layer in said vase, said vase being positioned in said notch in said base thereby orienting said vase at said angle when said liquid resin is poured into said vase such that said third layer has a diagonal orientation, said third layer resting upon said upper surface of said second layer, said third layer having an upper surface being oriented at an upward angle lying on a plane being oriented coplanar with said upper surface of said second layer;
a block of candle wax being heatable into a fluid wax, a predetermined amount of said fluid wax being pourable onto said third layer formed by said liquid resin such that said fluid wax hardens into a fourth layer in said vase, said vase being removed from said notch in said base thereby facilitating said vase to be positioned on the horizontal support surface thereby facilitating said vase to be oriented in a vertical orientation when said fluid wax is poured into said vase such that said fluid wax has a horizontal orientation, said fourth layer resting upon said upper surface of said third layer, said fourth layer having an upper surface lying on a plane being oriented parallel with said bottom wall of said vase;
a third container containing a powder being comprised of a light reflecting material, a predetermined amount of said powder being mixed with said predetermined amount of said liquid resin which forms said first layer thereby facilitating said first layer to sparkle wherein said powder is configured to enhance the ornamental appearance of said first layer, a predetermined amount of said powder being mixed with said predetermined amount of said liquid resin which forms said third layer thereby facilitating said third layer to sparkle wherein said powder is configured to enhance the ornamental appearance of said third layer;
a fourth container containing liquid pigment, a predetermined amount of said liquid pigment being mixed with said predetermined amount of said liquid resin which forms said first layer thereby facilitating said liquid pigment to alter the color of said first layer wherein said liquid pigment is configured to enhance the ornamental appearance of said first layer;
a wick being insertable into said fourth layer defined by said fluid wax before said fluid wax hardens thereby facilitating said wick to be embedded into said fourth layer when said fourth layer hardens, said block of candle wax being comprised of a combustible material thereby facilitating said fluid wax to be burned in said wick when said wick is ignited wherein said wick is configured to emit light for illuminating the immediate area around said vase, said wick having a lower end and an upper end, said wick including a disk having a top surface, said lower end of said wick being attached to said top surface of said disk such that said disk is embedded in said fourth layer when said fourth layer hardens thereby inhibiting said wick from being removable from said fourth layer, said wick extending upwardly through said upper surface of said fourth layer such that said upper end of said wick is exposed; and
an ornament being positionable within said vase when said gel wax is poured into said vase, said ornament being embedded in said gel wax when said gel was hardens in said vase, said gel wax being comprised of a translucent material thereby facilitating said ornament to be visible in said gel wax wherein said ornament is configured to enhance the ornamental appearance of said vase.
